(19) United States
(12) Patent Application Publication
(10) Pub. No.: US 2009/0128555 A1
(43) Pub. Date: May 21, 2009

(54) System and method for creating and using live three-dimensional avatars and interworld operability

(76) Inventor: William J. Benman, Los Angeles, CA (US)

Correspondence Address: William J. Benman, Suite 2740, 2049 Century Park East, Los Angeles, CA, 90067, US

(21) Appl. No.: 12/291,086

(22) Filed: Nov. 5, 2008

Related U.S. Application Data
(60) Provisional application No. 61/001,954, filed on Nov. 5, 2007.

(51) Int. Cl. G06T 15/00; G06F 3/048; G06F 15/16

(52) U.S. Cl. 345/419; 715/757

(57) ABSTRACT

A system and method for creating a live 3D avatar and effecting interworld operability. The system includes an arrangement for providing a 3D wireframe or surface; an arrangement for providing a series of images; and an arrangement for mapping the series of images onto the wireframe or surface. A mechanism is included for predistorting the images prior to mapping. An additional mechanism is included for simulating the lower body of the user, preferably based on the upper body thereof. Ideally, the system and method is implemented in software stored on a machine readable medium and executed by a processor. For interworld operability, a system and method are disclosed for creating an interworld avatar and using said avatar to navigate between virtual worlds on disparate platforms comprising: at least one client machine; at least one world server; at least one routing server; an arrangement for connecting each of the servers and at least one of the servers to the client machine; and software stored on a medium adapted for execution by the client machine or one of the servers for providing an avatar for use in a world provided by the world server via the routing server.

### CROSS REFERENCE TO RELATED APPLICATIONS

This application claims priority from provisional patent application No. 61/001,954 entitled SYSTEM AND METHOD FOR CREATING AND USING LIVE THREE-DIMENSIONAL AVATARS AND SYSTEM AND METHOD FOR MANAGING AVATAR IDENTITY WHILE NAVIGATING BETWEEN VIRTUAL WORLD PLATFORMS filed Nov. 5, 2007 by William J. Benman, (Docket Nos. IVN-8,9) the teachings of which are explicitly incorporated herein by reference.

### BACKGROUND OF THE INVENTION

1. Field of the Invention

This invention relates to computer graphics and video imagery. Particularly, this invention relates to systems and methods for providing avatars for use in virtual environments.

2. Description of the Related Art

U.S. Pat. No. 6,798,407, SYSTEM AND METHOD. FOR PROVIDING A FUNCTIONAL VIRTUAL ENVIRONMENT WITH REAL TIME EXTRACTED AND TRANSPLANTED IMAGES by William J. Benman, issued Sep. 28, 2004, and U.S. Pat. No. 5,966,130, INTEGRATED VIRTUAL NETWORKS by William J. Benman, issued Oct. 12, 1999, the teachings of both of which are incorporated herein by reference, disclose and claim systems for enabling users to see and interact with each other as live images in computer generated environments in real time. This technology is named Silhouettesm and is currently offered as a service via a highly realistic computer generated environment called the Nexosₛₘ by Integrated Virtual Networks, Inc. of Los Angeles, Calif.

As disclosed in these patents, a live avatar is an avatar with a real time live video image texture. The live avatar is based on an image captured with typically a single camera. This creates a two-dimensional avatar.

To further enhance the user experience, there is a need to render the live avatar as a fully three-dimensional avatar.

In addition, computer generated massively multi-user online virtual worlds such as Cybertown, Second Life, Active Worlds and others are experiencing a rapid growth in users for a variety of personal, entertainment, educational and business applications. Unfortunately, although Cybertown is based on the VRML (Virtual Reality Modeling Language) and the X3D extension thereof, many if not most of the worlds are based on proprietary code. This is problematic inasmuch as each world currently requires a computer-generated avatar to represent the user.

These avatars are often time consuming to create in a life-like manner and nonlife-like avatars are less personal and inadequate for business and other applications. More importantly, there are two limitations associated with conventional virtual world technology: 1) an avatar created for one world can not be used in another world and 2) a user in one world can not easily navigate to another, that is, there is no interworld operability.

Hence, an additional need remains in the art for a system or method for providing a versatile interworld avatar and for navigating between virtual worlds.

### SUMMARY OF THE INVENTION

The need in the art is addressed by the system and method of the present invention for creating a live 3D avatar. In the best mode, the inventive system includes an arrangement for providing a 3D wireframe or surface; an arrangement for providing a series of images; and an arrangement for mapping the series of images onto the wireframe or surface.

In the illustrative embodiment, a mechanism is included for predistorting the images prior to mapping. An additional mechanism is included for simulating the lower body of the user, preferably based on the upper body thereof.

Ideally, the system and method is implemented in software stored on a machine readable medium and executed by a processor.

For interworld operability or ‘interoperability’, a system and method are disclosed for creating an interworld avatar and using said avatar to navigate between virtual worlds on disparate platforms comprising: at least one client machine; at least one world server; at least one routing server; an arrangement for connecting each of the servers and at least one of the servers to the client machine; and software stored on a medium adapted for execution by the client machine or one of the servers for providing an avatar for use in a world provided by the world server via the routing server.

### BRIEF DESCRIPTION OF THE DRAWINGS

FIG. 1 shows a rear view of a wireframe of a human body in accordance with conventional teachings.

FIG. 2 which shows a front view of the wireframe of FIG. 1 with a single frame of image texture transplanted in accordance with the present teachings.

FIG. 3 shows an image captured with a single web camera in accordance with conventional teachings.

FIG. 4 shows an image predistorted to create a ‘pelt’ using a process such as the AvMaker program licensed by CyberExtruder.

FIG. 5 shows frontal view of a resulting static avatar by which the predistorted image of FIG. 4 is wrapped on a wireframe using the Avaker process of CyberExtruder.

FIG. 6 shows a perspective view of the static avatar of FIG. 5.

FIG. 7 is a block diagram of an illustrative embodiment of a system for creating live three-dimensional avatars in accordance with the present teachings.

### DESCRIPTION OF THE INVENTION

Illustrative embodiments and exemplary applications will now be described to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Live 3D Avatars:

U.S. Pat. No. 6,798,407, SYSTEM AND METHOD FOR PROVIDING A FUNCTIONAL VIRTUAL ENVIRONMENT WITH REAL TIME EXTRACTED AND TRANSPLANTED IMAGES by William J. Benman, issued Sep. 28, 2004, and U.S. Pat. No. 5,966,130, INTEGRATED VIRTUAL NETWORKS by William J. Benman, issued Oct. 12, 1999, the teachings of both of which are incorporated herein by reference, disclose and claim systems for enabling users to see and interact with each other as live images in computer generated environments in real time. This technology is named Silhouettesm and is currently offered as a service via a highly realistic computer generated environment called the Nexosₛₘ by Integrated Virtual Networks, Inc. of Los Angeles, Calif. These patents describe a system adapted for use in a client server topology with the client systems including a personal computer, web camera, microphone, speakers and a broadband network connection. Unfortunately, with a single camera, the resulting live avatars are two-dimensional. As noted above, for some applications, there is a need for a fully three-dimensional live avatar solution; this disclosure addresses that need.

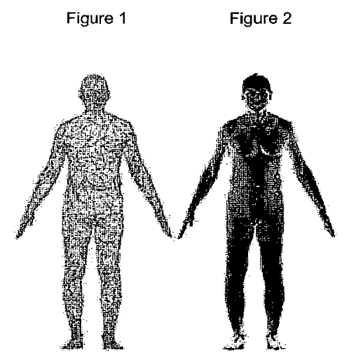

In accordance with the present invention, a live 3D avatar is implemented by first creating a 3D wireframe using any of several methods currently known in the art. See FIG. 1 which shows a wireframe of a human body in accordance with conventional teachings. See http://www.flcmidwest.org/200606_{—}02.html.

In the best mode, the wireframe is created from the user's image as captured by a video or still camera. In this case, the wireframe is created using a methodology such as that described by Dr. Wonsook Lee et al. in “Generating Animatable 3D Virtual Humans from Photographs”, Won-Sook Lee, Jin Gu, Nadia Magnenat-Thalmann, Computer Graphics Forum (SCIE), ISSN 0167-7055, Volume 19, Issue 3, pp. 1-10, also in Eurographics'2000 Proc., Interlaken, Switzerland, August 2000, http://www.site.uottawa.ca/˜wslee/publication/EG2000.pdf. As an alternative, the wireframe may be created using a technique such as that used by CyberExtruder (www.cyberextruder.com) or acquired from CyberExtruder. The CyberExtruder approach may be preferred inasmuch as the wireframe and initial surface texture are created from a single camera image.

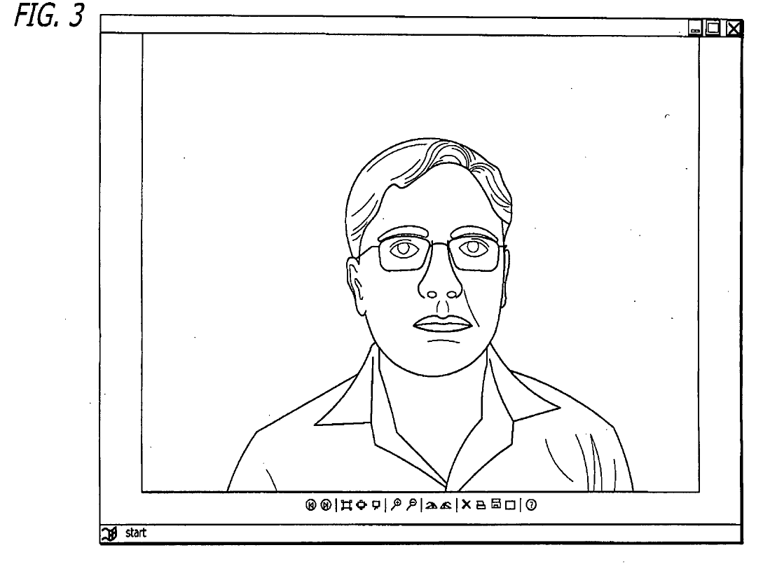

Next, the surface texture on the wireframe, if any, is removed and updated with a series of live vide image textures such as those provided by Silhouette as disclosed and claimed in the above-identified Benman patents, at least 22 frames per second, to create a real time image. This is depicted FIG. 2 which shows a front view of the wireframe of FIG. 1 with a single frame of image texture transplanted in accordance with the present teachings.

In the best mode, each frame of live avatar image data is predistorted so that when it is subsequently mapped or wrapped onto the wireframe, the image accurately represents the user in accordance with the requirements of the user or customer. This is illustrated in FIGS. 3, 4 and 5.

FIG. 3 shows an image captured with a single web camera in accordance with conventional teachings.

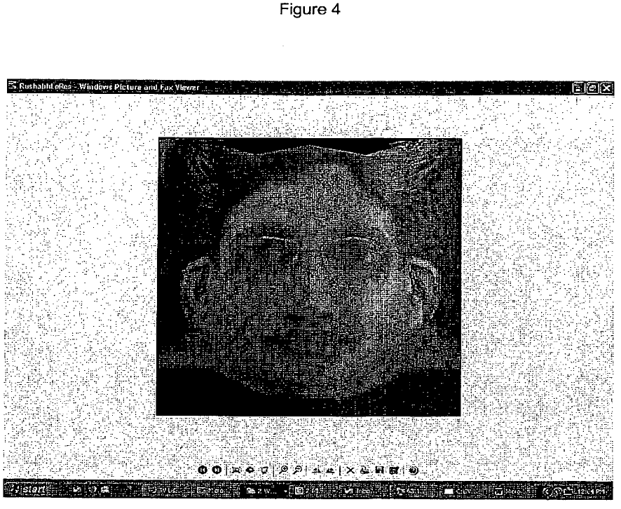

FIG. 4 shows an image predistorted to create a ‘pelt’ using a process such as the AvMaker program licensed by CyberExtruder.

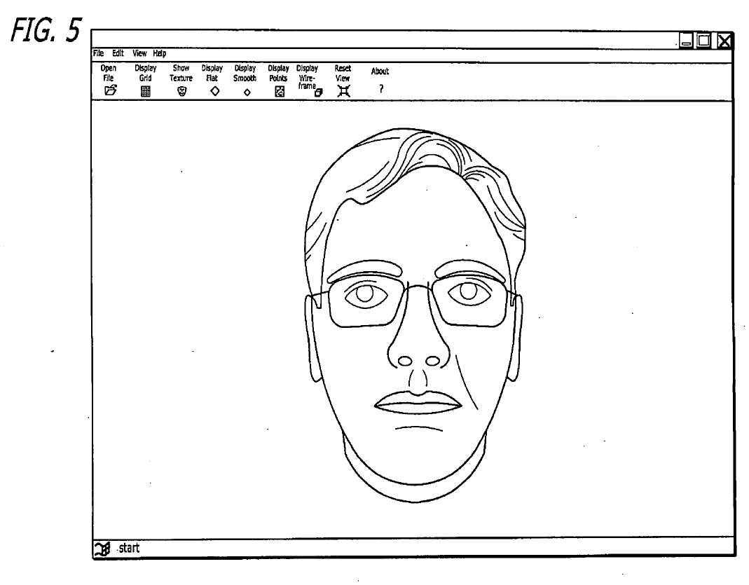

FIG. 5 shows frontal view of a resulting static avatar by which the predistorted image of FIG. 4 is wrapped on a wireframe using the Avaker process of CyberExtruder.

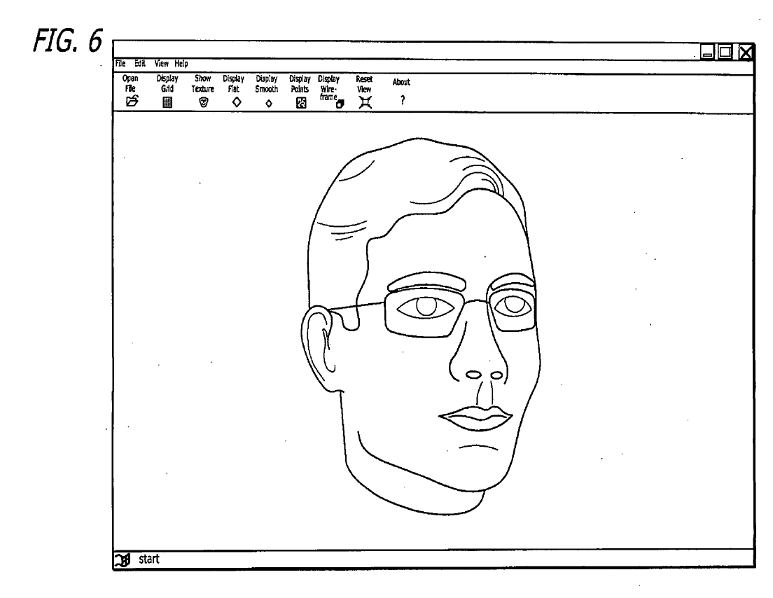

FIG. 6 shows a perspective view of the static avatar of FIG. 5. This image was created with a screen capture after rotating the avatar approximately 45 degrees about an axis extending virtually through the head of the avatar.

In accordance with the present teachings, the image texture on the static avatar of FIGS. 5 and 6 is updated at rate sufficiently high to create a realistic looking live avatar. Preferably, these steps are executed by the sending client and sent to the server for distribution to others within range and field-of-view in the virtual world.

Next, the live avatar is received by a client machine and transplanted into the user's virtual world at the coordinates supplied by the server. The wireframe need not be sent at real time frame rates. Instead, the wireframe may be sent initially and thereafter only if changes or updates are required therein. In this case, the predistorted live avatar image frames are received and transplanted on the client end.

As an alternative, the texture mapping may be performed at the sending client or at the server without departing from the scope of the present teachings.

As another alternative implementation, the wireframe may be eliminated and replaced with a generic surface or mannequin onto which the predistorted image frames are mapped or displayed. In the best mode, the mannequin is invisible to the user to minimize the creation of artifacts.

In any case, as a further extension of the invention, the lower body of the user may be simulated by the computer and transplanted. In the preferred mode, the lower body is based on the color and textures captured by the camera in the upper body.

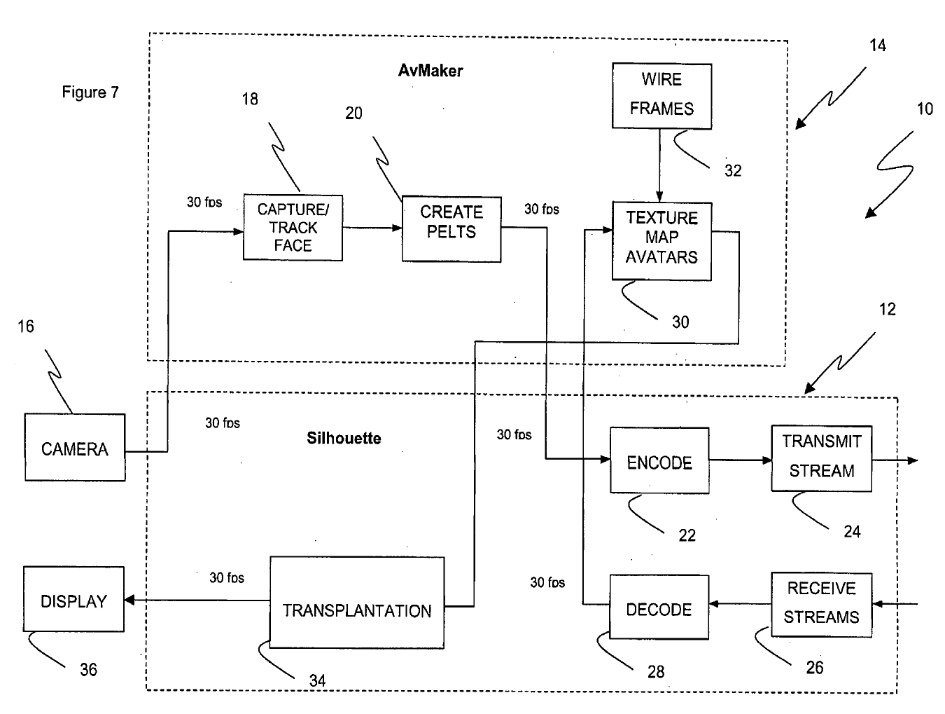

FIG. 7 is a block diagram of an illustrative embodiment of a system for creating live three-dimensional avatars in accordance with the present teachings. As shown in FIG. 7, the system 10 includes a Silhouette client 12 modified for live 3D avatars in accordance with the present teachings and an AvMaker module 14. The Silhouette client 12 sends AvMaker 14 image frames from a camera 16 preferably at 22-30 frames per second (fps) using the pixel data format [120×160×3]. A capture/track face module 18 of AvMaker processes this data, finds and tracks the face in each frame of image data and feeds the data to a transformation module 20. The transformation module 20 creates pelts (such as that shown in FIG. 4) and returns pelts to an encoder 22 of the Silhouette client 12 at 22-30 fps using the same data format. In the best mode, AvMaker will need to find the face only once per session and can track the face with a priori data after initial acquisition. The Silhouette client 12 then encodes this data, packetizes it with audio data and send it to the server through the Internet via a transmit module 24.

On the receive side, after routing by a routing server (not shown), the Silhouette client then receives the video data from the server (26), decodes it (28) and sends it to the AvMaker at 22-30 fps using the pixel texture format [120×160×4]. A mapper 30 in AvMaker 14 maps this data as a texture map onto wire frames stored in memory 32 to create the live avatars at a texture update rate of 22-30 fps and returns VRML avatars to the transplantation module 34 of the Silhouette client 12. In the best mode, the wireframe is a full body wire frame and the texture chosen for the finished avatar's skin matches the texture and color of the user. The transplantation module determines where to insert the avatar in-world using the teachings of the patents incorporated herein by reference. The avatar is then displayed in the 3D world as a live fully three-dimensional avatar.

It should be noted that the present invention is not limited to use with VRML or X3D language based worlds. Indeed, the present teachings may be implemented in worlds based on other languages or protocols with departing from the scope of the invention.

Interoperability:

In accordance with the present teachings, an interworld avatar is provided by using, in the first instance, a Silhouette live avatar in each proprietary world, preferably in the manner disclosed herein. In one embodiment, this is made possible by exporting the 3D world content and coordinates from each proprietary platform to an open standard such as VRML or X3D and communicating this exported open-standard content and the coordinates therefor to the Silhouette world content server (aka the ‘Nexos’). However, the present invention is not limited to an exporting of the content to VRML or X3D so long as the Silhouette world content server is provided with the coordinates and content of the worlds through which the user will be navigating.

In a first embodiment, the 3D world content for each proprietary world and each live avatar stream is provided to each user directly by a Silhouette content and routing server infrastructure (hereinafter the IVN server infrastructure).

In a second embodiment, the 3D world content is downloaded to each user by the proprietary world server infrastructure (e.g. Cybertown, Second Life or Active Worlds) and the live avatar streams are provided by a Silhouette routing server infrastructure, maintained either by IVN or the proprietary platform owner, using the stored content and coordinates provided by the proprietary world platforms and user coordinate data provided by each user's client computer.

In yet another embodiment, the avatar used in each proprietary world is converted to the open standard (e.g. VRML or X3D) and stored on the IVN server infrastructure (or on a client machine in communication with the IVN server infrastructure) for use in place of the Silhouette avatar when a user navigates to an associated proprietary world using the IVN infrastructure (i.e. via the Nexos). Here again, the 3D world content may be served to the user by the IVN infrastructure or the proprietary world infrastructure. Each avatar in this case may be routed by the IN infrastructure when the user is outside of the home world (outworld) and by either the IVN infrastructure or the home (proprietary) world when the user navigates to and within the home world (inworld). In the latter case, handoff is effected between the IVN infrastructure and the proprietary world by either passing data regarding the avatar parameters or user ID information between worlds or passing the avatar itself and converting it on receipt to a standard (proprietary or open) that is appropriate for use inworld.

The interworld avatar may be a composite avatar with avatars for different world overlaid as textures onto an appropriate surface or wireframe. Then, as the user navigates between worlds, the user's client machine selects the appropriate avatar (wireframe and texture) for use in the selected world and transmits this information to the routing server for distribution to other users. As an alternative, as mentioned above, the user's native avatar (e.g. Silhouette live avatar) is provided by the client and transformed as the user moves between worlds by the receiving world server or receiving world client machines.

Hence, it can be seen that by using Silhouette and the IVN infrastructure, 1) an avatar can be created for one world and used in another world and 2) a user in one world can easily navigate to another such that the user experiences interworld operability.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A system for creating a live 3D avatar comprising:
means for providing a 3D wireframe or surface;
means for providing a series of images; and
means for mapping said series of images onto said wireframe or surface.

2. The invention of claim 1 further including means for predistorting said images prior to mapping.

3. The invention of claim 1 further including means for simulating the lower body of the avatar.

4. The invention of claim 3 wherein the lower body of the avatar is based on the upper body thereof.

5. A system for creating a live 3D avatar comprising:
a camera providing a series of images;
means for predistorting said images;
means for transmitting said predistorted images via a network;
means for receiving said transmitted predistorted images via said network;
memory for storing a 3D wireframe or surface; and
means for mapping said received predistorted images onto said wireframe or surface.

6. The invention of claim 5 further including means for simulating the lower body of the avatar.

7. The invention of claim 6 wherein the lower body of the avatar is based on the upper body thereof.

8. A system for creating an interworld avatar and using said avatar to navigate between virtual worlds on disparate platforms comprising:
at least one client machine;
at least one world server;
at least one routing server;
means for connecting each of said servers and at least one of said servers to said client machine; and
software stored on a medium adapted for execution by said client machine or one of said servers for providing an avatar for use in a world provided by said world server via said routing server.
